(19) United States
(12) Patent Application Publication
(10) Pub. No.: US 2015/0324340 A1
(43) Pub. Date: Nov. 12, 2015

(54) METHOD FOR GENERATING REFLOW-CONTENT ELECTRONIC BOOK AND WEBSITE SYSTEM THEREOF

(71) Applicant: Golden Board Cultural and Creative Ltd., Co,, Taipei City (TW)

(72) Inventors: Yin-Hao Tsui, Taipei City (TW); Ting-Yu Lai, Taipei City (TW)

(21) Appl. No.: 14/700,221

(22) Filed: Apr. 30, 2015

(30) Foreign Application Priority Data
May 7, 2014 (TW) 103116324

(51) Int. Cl. G06F 17/24; H04L 29/08; G06F 17/28; G06F 3/0483; G06F 3/0484

(52) U.S. Cl. CPC G06F 17/24; G06F 3/0483; G06F 3/04842; G06F 17/28; H04L 67/02

(57) ABSTRACT

A method for generating reflow-content electronic book and a website system for the same are provided. In the method, firstly, an original paragraph of a page content in a digital file is recognized. Then, an arrangement type of lines in the original paragraph is recognized, and the lines are connected to form a reflow-content paragraph based on the arrangement type, followed with calculating a recognizing confidence value corresponding to the reflow-content paragraph. Next, displaying the reflow-content paragraph in an edit interface, followed with marking the off-threshold reflow-content paragraph. Therefore, the user can check or revise the marked reflow-content paragraph in the edit interface. Last, all of the reflow-content paragraphs are saved as a reflow-content electronic book file. Accordingly, unstructured book files can be simply converted into reflow-content electronic book files, and those reflow-content paragraphs where errors might occur can be checked rapidly.

### CROSS-REFERENCES TO RELATED APPLICATIONS

This non-provisional application claims priority under 35 U.S.C. §119(a) on Patent Application No. 103116324 filed in Taiwan, R.O.C. on 2014 May 7, the entire contents of which are hereby incorporated by reference.

### BACKGROUND

1. Technical Field

The instant disclosure relates to a method for generating an electronic book, in particular, to a method for generating reflow-content electronic book and website system thereof.

2. Related Art

As technology advances, the use of portable electronic devices (e.g., tablet computers, mobile phones, etc.), is becoming increasingly widespread. The portable electronic devices are commonly applied for net surfing or for reading electronic books. As a result, since the need of the digital books is largely increased, the book publishers are also starting to publish digital books in addition to the traditional physical books.

A common method for converting a physical book into an electronic book file is to import an unstructured file (e.g., PDF file) of the physical book to the portable electronic device directly. However, though the PDF file format allows the texts of the electronic book to be displayed on the portable electronic device, a user cannot read the texts of the electronic book conveniently. Specifically, when the user wants to see a certain text in details in one page of the electronic book (especially in the case of the user using a small-screen mobile phone to read the text), the user has to zoom-in the text. Next, if the user wants to go through the reading in the zoom-in mode, the user has to drag the page to shift for displaying the proper texts. Therefore, the electronic book produced by the conventional method is quite inconvenient for reading.

Some electronic book producers make an additional treatment for the unstructured files. In other words, the unstructured files are converted into structured files (e.g., html files) by a conventional file converting system. However, the conventional file converting system may fail to convert the files in a correct manner, and the converted files cannot be adapted to the portable electronic devices. Consequently, the electronic book producers have to consume manpower to retrieve the texts and figures of the books manually, followed with reediting the retrieved texts and figures.

### SUMMARY

To address the abovementioned issues, the instant disclosure provides a method for generating reflow-content electronic book and a website system for generating reflow-content electronic book. The method and the website system can solve the issues encountered in the conventional.

The method for generating reflow-content electronic book comprises following steps.

Firstly, receiving a digital file, wherein the digital file comprises at least one page content. Then, recognizing a plurality of words of at least one original paragraph of the at least one page content, wherein the words are aligned into a plurality of lines along a writing direction. And then, recognizing an arrangement type of the lines to connect the words of the lines to form at least one reflow-content paragraph based on the arrangement type of the lines, followed with calculating a recognizing confidence value corresponding to each of the at least one reflow-content paragraph. Next, displaying the words of the at least one reflow-content paragraph in an edit interface, followed with marking those reflow-content paragraphs whose recognizing confidence values are less than a threshold value. Therefore, the user can check or revise the marked reflow-content paragraph in the edit interface. Last, all of the reflow-content paragraphs are saved as a reflow-content electronic book file. Based on the aforementioned steps, unstructured book files are converted into reflow-content electronic book files, and the user can rapidly check those reflow-content paragraphs where errors might occur.

Here, the edit interface may comprise a plurality of device options respectively corresponding to a plurality of virtual display devices. The device options allow the user to select one of the virtual display devices to display an image frame having the reflow-content paragraph in the edit interface, wherein the sizes of screens of the virtual display devices are different. Accordingly, the user can edit the reflow-content paragraph in the edit interface, and the texts and the text formats presented in the edit interface are those shown on a corresponding physical display device

In an implementation aspect, in the step of recognizing a plurality of words of at least one original paragraph of the at least one page content, further comprising: recognizing the words of each of the at least one page content and summarizing a two-dimensional coordinate of each of the words, wherein the two-dimensional coordinate comprises a horizontal coordinate and a vertical coordinate; determining an upper boundary and a lower boundary based on the majority of the vertical coordinates of the words and determining a left boundary and a right boundary based on the majority of the horizontal coordinate of the words; and defining the words within the upper and lower boundaries and the left and right boundaries of each of the at least one page content as an article. Accordingly, other contents, such as the page number part, the section part, or the annotation part, would not be concluded into the article, and the determination of the boundaries can be further improved.

In one implementation aspect, the arrangement type may comprise the font, the size, the indentation distance, the wording spacing and the line spacing. For example, firstly, the indentation distance of the original paragraph is detected, and then each of the reflow-content paragraphs in the article is arranged based on the indentation distance of the corresponding original paragraph. Accordingly, the success rate in converting original paragraphs into reflow-content paragraphs can be improved.

In some implementation aspects, the method for generating reflow-content electronic book further comprises a non-text block recognizing step. In the step, firstly, recognizing a plurality of pictures or charts as non-text blocks, and then recognizing an interval between two adjacent non-text blocks, finally combining those adjacent non-text blocks with the interval there between being less than a predefined value to form an entire chart, a table or a graph. Accordingly, the broken pieces of an entire chart, table, or graph would not be recognized as reflow-content paragraphs.

A website system for generating reflow-content electronic book is further provided. The website system comprises a network receiving module, an image recognizing module, and a website interface module.

The network receiving module receives a digital file uploaded by a user, wherein the digital file comprises at least one page content. The image recognizing module recognizes a plurality of lines along a writing direction, wherein the words are aligned into a plurality of lines along a writing direction. And, the image recognizing module recognizes an arrangement type of the lines, so that the image recognizing module connects the words of the lines to form at least one reflow-content paragraph based on the arrangement type of the lines and calculates a recognizing confidence value corresponding to each of the at least one reflow-content paragraph. The website interface module comprises an edit interface to display words of the at least one reflow-content paragraph, wherein the edit interface marks the reflow-content paragraphs whose recognizing confidence values are less than a threshold value. Accordingly, the user can rapidly check those reflow-content paragraphs where errors might occur.

In one implementation aspect, the edit interface has a first browsing window and a second browsing window aligned parallel with the first browsing window. The first browsing window displays the original paragraph of the page content. The second browsing window displays at least one recognized reflow-content paragraph corresponding to the page content displayed within the first browsing window. Therefore, the user may compare the reflow-content paragraphs with the original paragraphs in a convenient manner.

In one implementation aspect, the edit interface further comprises an edit tool set and a plurality of device options respectively corresponding to a plurality of virtual display devices. The device options allow the user to select one of the virtual display devices to display an image frame in the second browsing window, wherein the sizes of screens of the virtual display devices are different. The edit tool set is provided for editing the at least one reflow-content paragraph displayed within the second browsing window. Accordingly, the user can check the same electronic book different display devices having different screen resolutions, and the user can edit the texts of the electronic book promptly.

In one implementation aspect, the edit interface further comprises a save button for saving all of the recognized reflow-content paragraphs as a reflow-content electronic book file.

In one implementation aspect, the edit interface further comprises a jump button for sequentially displaying the marked reflow-content paragraphs in the second browsing window.

Based on the above, the method for generating reflow-content electronic book and the website system thereof may be adapted to the user to rapidly check those reflow-content paragraphs where errors might occur and allow the user to save the electronic book file promptly. In addition, the reflow-content electronic book generated by the method or the website system may be flexibly displayed on different devices having different sizes of screens. Furthermore, based on the paragraph recognizing step, the possibility in paragraph misrecognizing can be reduced.

Detailed description of the characteristics and the advantages of the disclosure is shown in the following embodiments, with the technical content and the implementation of the disclosure should be readily apparent to any person skilled in the art from the detailed description, and the purposes and the advantages of the disclosure should be readily understood by any person skilled in the art with reference to content, claims and drawings in the disclosure.

### BRIEF DESCRIPTION OF THE DRAWINGS

The disclosure will become more fully understood from the detailed description given herein below for illustration only, and thus not limitative of the disclosure, wherein:

FIG. 1 is a flowchart illustrating an exemplary embodiment of a method for generating reflow-content electronic book according to the instant disclosure;

FIG. 2 is a flowchart illustrating the step S200 of the method for generating reflow-content electronic book according to the instant disclosure;

FIG. 3 is a flowchart illustrating the step S400 of the method for generating reflow-content electronic book according to the instant disclosure;

FIG. 4 illustrates a schematic view of a page content of the method for generating reflow-content electronic book according to the instant disclosure;

FIG. 5 illustrates a schematic view of a window of an edit interface of the method for generating reflow-content electronic book according to the instant disclosure; and

FIG. 6 illustrates a schematic view of a website system for generating reflow-content electronic book according to the instant disclosure.

### DETAILED DESCRIPTION

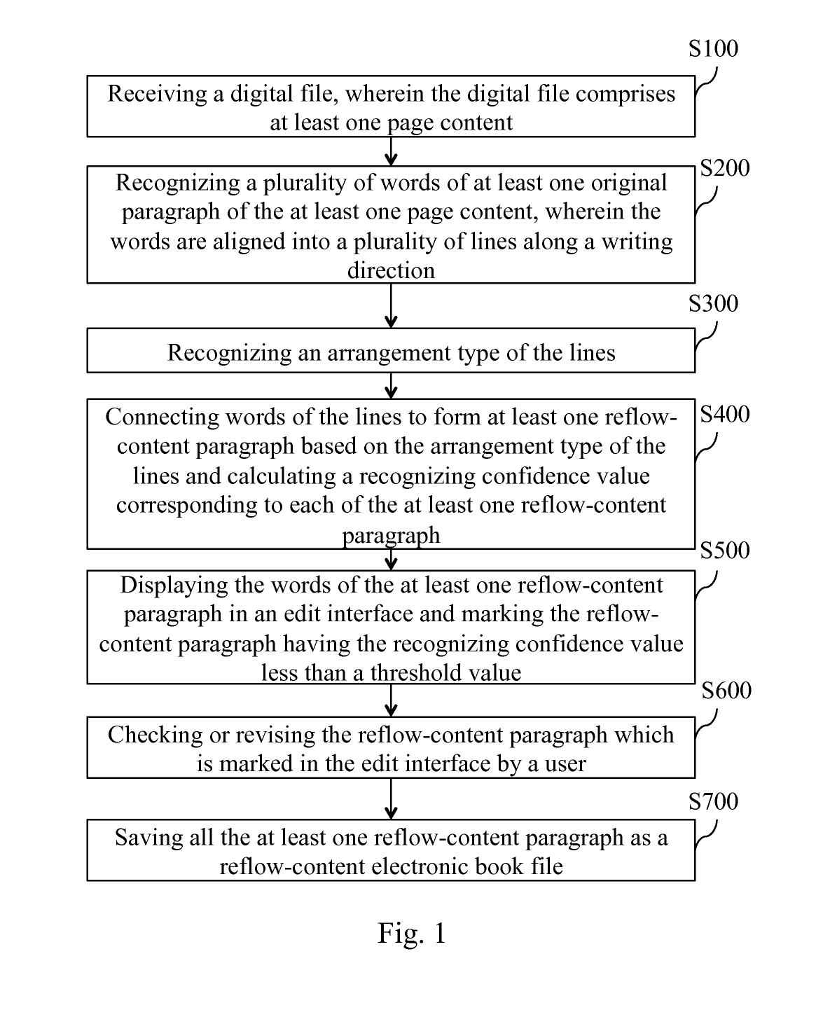

Please refer to FIG. 1, illustrating a flowchart of an exemplary embodiment of a method for generating reflow-content electronic book according to the instant disclosure. The method for generating reflow-content electronic book may be carried out by a website system which will be described in the foregoing paragraphs. The method for generating reflow-content electronic book is described as below.

In step S100, the website system receives a digital file uploaded by a user, and wherein the digital file comprises at least one page content. Here, the format of the digital file may be, but not limited to, the PDF (portable document format) developed by Adobe systems. It should be understood that the PDF files may be, but not limited to, converted from word files or other publishing software files. Alternatively, an OCR (optical character recognition) procedure may be applied to recognize scanned graphic files to generate PDF files.

Step S200: recognizing a plurality of words of at least one original paragraph of the at least one page content, and the words are aligned into a plurality of lines along a writing direction. Here, the writing direction may be vertical or horizontal, but embodiments are not limited thereto.

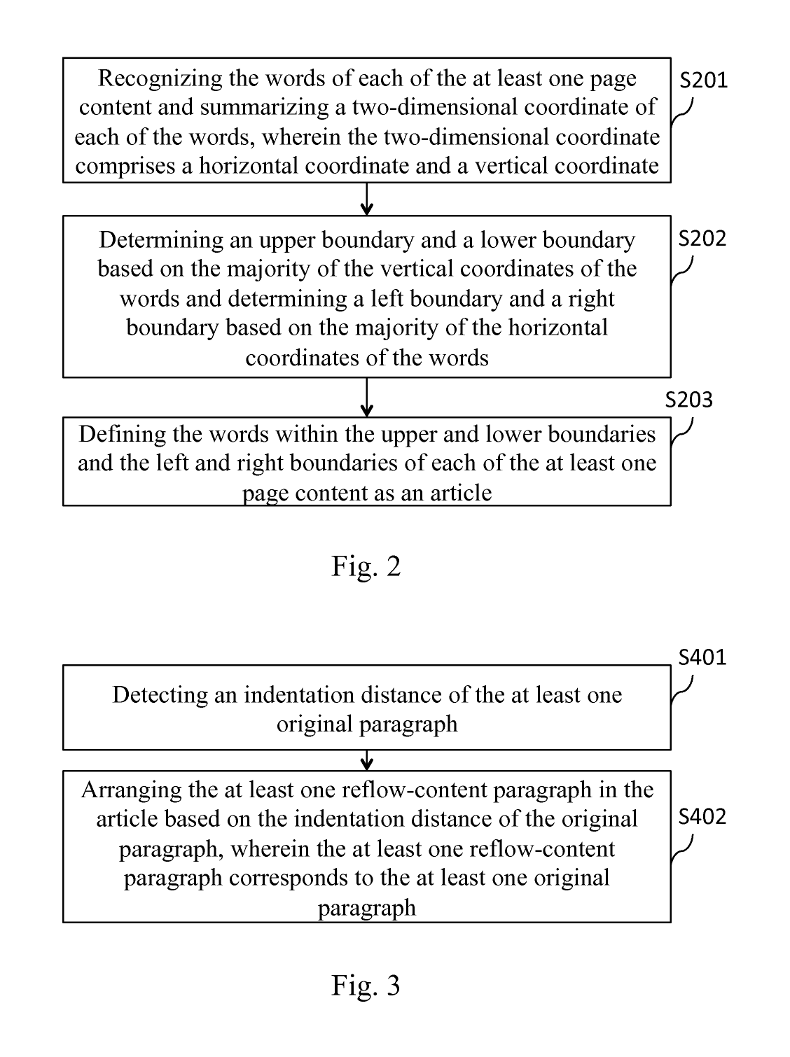

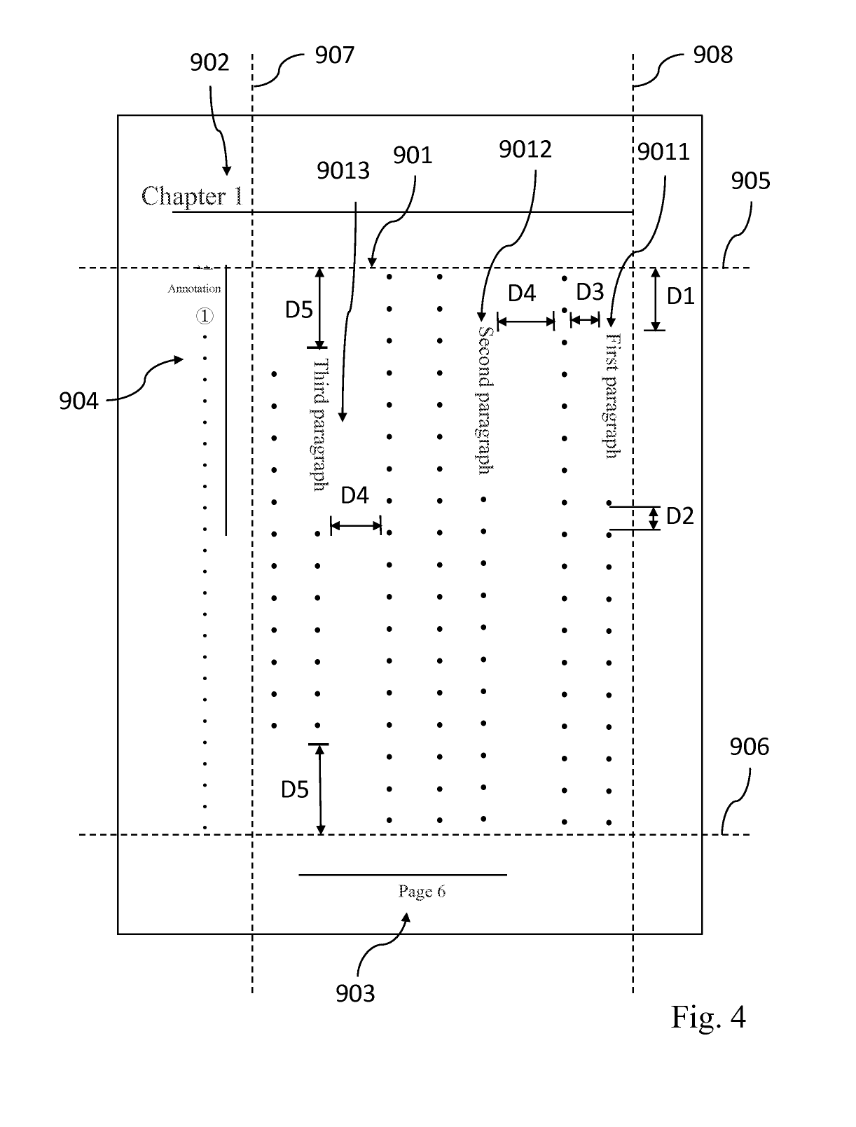

Please refer to FIG. 2, which illustrates a flowchart of the step S200 of the method for generating reflow-content electronic book according to the instant disclosure. Firstly, in step S201, recognizing the words of each of the at least one page content and summarizing a two-dimensional coordinate of each of the words, wherein the two-dimensional coordinate comprises a horizontal coordinate and a vertical coordinate. And then, in step S202, determining an upper boundary and a lower boundary based on the majority of the vertical coordinate of the words and determining a left boundary and a right boundary based on the majority of the horizontal coordinate of the words. Last, in step S203, defining the words within the upper and lower boundaries and the left and right boundaries of each of the at least one page content as an article 901 (as shown in FIG. 4).

Please refer to FIG. 4, illustrating a schematic view of the page content of the method for generating reflow-content electronic book according to the instant disclosure. Here, the writing direction is vertical. The page may comprise the article 901, a section part 902, a page number part 903, and an annotation part 904. The section part 902 is above the article 901. The page number part 903 is under the article 901. The annotation part 904 is at the left side of the article 901. After each of the pages is summarized, the vertical coordinates of the first word and the last word of each line of the article 901 would be the most frequently appeared vertical coordinates, and the horizontal coordinates of each of the words in the first line and the last line of the article 901 would be the most frequently appeared horizontal coordinates. Accordingly, the upper boundary 905, the lower boundary 906, the left boundary 907, and the right boundary 908 can be figured out and defined. On the other hand, because the annotation part 904 appears randomly, the determination of the boundaries would not be affected by the annotation part 904.

Usually, for each page, the words of the article 901 would be confined within the same region, and the font, the size, or the style of the words of the article 901 would be different from that of the words outside of region of the article 901. Based on this, the determination of the boundaries would be further improved.

Please refer back to FIG. 1. Step S300: recognizing an arrangement type of the lines. Here, the arrangement type may comprise, but not limited to, the font, the size, the indentation distance D1, D5, the wording spacing D2, and the line spacing D3, D4 (as shown in FIG. 4).

And then, step S400: connecting the words of the lines to form at least one reflow-content paragraph 914 based on the arrangement type of the lines and calculating a recognizing confidence value corresponding to each of the at least one reflow-paragraph 914.

Please refer to FIG. 3, illustrating a flowchart of the step S400 of the method for generating reflow-content electronic book according to the instant disclosure. To recognize which original paragraphs the lines belong to, firstly the indentation distance D1 of each of the original paragraphs is detected (i.e., step S401). And then, each of the at least one reflow-content paragraphs 914 in the article 901 is arranged based on the indentation distance D1 of the corresponding original paragraph. That is, the indented line is recognized as the first line of the corresponding reflow-content paragraph 914, and the indented line is connected to words followed thereafter to form one reflow-content paragraph 914. It should be understood that the formation of the reflow-content paragraphs 914 is not limited thereto. In an embodiment, the original paragraphs may be recognized based on the difference between the line spacing D3 and the line spacing D4. As shown in FIG. 4, page 6 of the article 901 includes a first paragraph 9011, a second paragraph 9012, and a third paragraph 9013. The line spacing D4 between the last line of the first paragraph 9011 and the first line of the second paragraph 9012 is different from the line spacing D3 between the lines within one paragraph. Accordingly, the lines belonging to each of the original paragraphs may be recognized and, respectively, connected together to form corresponding reflow-content paragraphs 914 based on the difference between the line spacing D3 and the line spacing D4. Here, the indentation distance may not be adapted to the beginning of the line, but may be adapted to the whole paragraph (i.e., the indentation distance D5).

Here, the recognizing confidence value is the recognition success rate calculated based upon several parameters. The parameters, may be, but not limited to, the degree of uniformity of the character formats (including the font, the size, the word spacing, the line spacing, etc.) of the words in the same reflow-content paragraph 914. For example, the higher the degree of uniformity of the character formats of the words in the same reflow-content paragraph 914 is, the higher recognizing confidence value is.

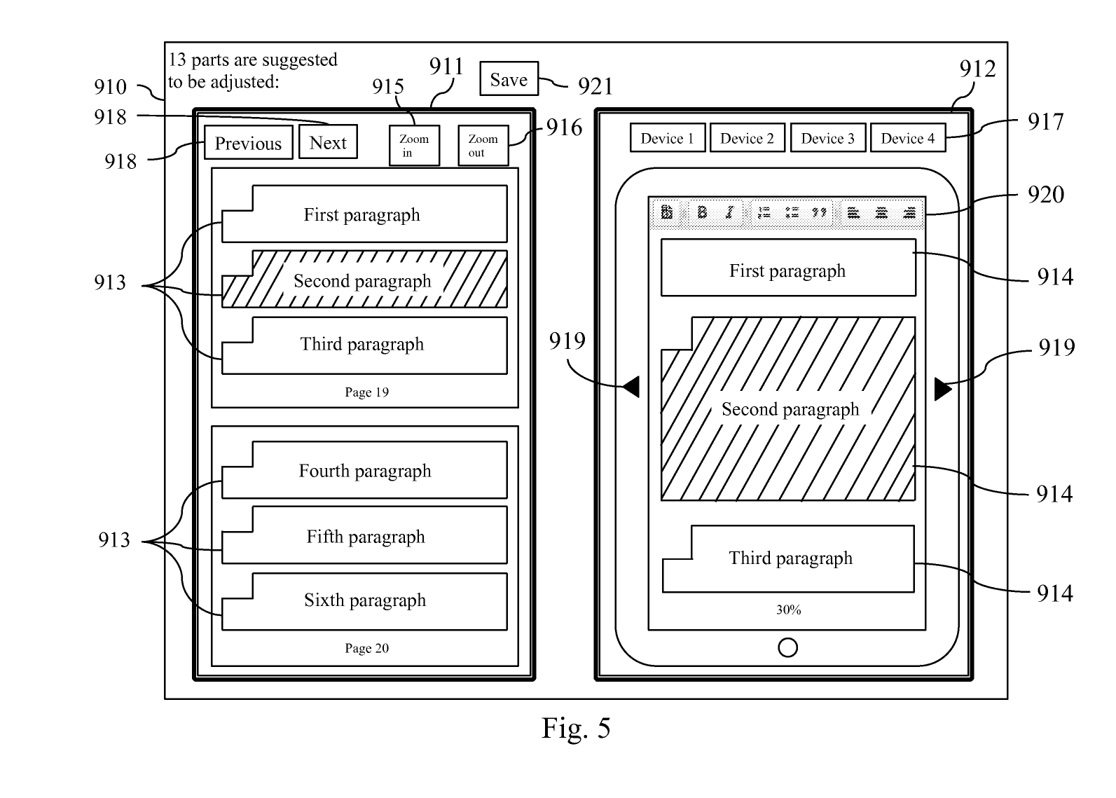

After the reflow-content paragraph 914 is generated, an edit interface 910 is provided (as shown in FIG. 5), so that the words of the reflow-content paragraph 914 is displayed within the edit interface 910. In addition, those reflow-content paragraphs 914 (i.e., the paragraphs with slanting lines) having recognizing confidence value less than a threshold value are marked.

FIG. 5 illustrates a schematic view of a window of the edit interface 910 of the method for generating reflow-content electronic book according to the instant disclosure. As shown in FIG. 5, the edit interface 910 has a first browsing window 911 and a second browsing window 912 parallel with the first browsing window 911. The first browsing window 911 displays the at least one page content to present the original paragraph 913 of the page. The second browsing window 912 displays at least one recognized reflow-content paragraph 914 corresponding to the at least one page content. During the recognition, when the recognizing confidence value of one reflow-content paragraph 914 is less than the threshold value and has to be checked manually, the original paragraph 913 corresponding to that reflow-content paragraph 914 would be marked in the first browsing window 911. The marking can be presented by highlighting, frame-selecting, underlining, word-color adjusting, etc. Accordingly, the user can preferentially check those parts which may be wrong, thus speeding up the speed in document proofreading.

The edit interface 910 may further comprise an edit tool set (i.e., an edit toolbar 920) and a plurality of device options respectively corresponding to a plurality of virtual display devices (i.e., device selecting button sets 917). The device selecting button sets 917 allows the user to select one of the virtual display devices to display an image frame in the second browsing window 912, wherein the image frame has the reflow-content paragraph 914. For example, the “device 1” button in the device selecting button sets 917 is the iPad tablet manufactured by Apple Inc, and the “device 2” button in the device selecting button sets 917 is the Galaxy S4 smart phone manufactured by Samsung Electronics Co., Ltd. In other words, the sizes of screens of the virtual display devices are different. Based on this, the user can freely choose different device selecting button sets 917 to display an electronic book in different display devices so as to edit or adjust the words of the electronic book accordingly. The edit toolbar 920 allows the user to edit the reflow-content paragraph 914 displayed within the second browsing window 912. For example, the user can adjust the font, the typeface, the alignment, or other formats of the words of the reflow-content paragraph 914.

As shown in FIG. 5, the edit interface 910 may comprise several jump buttons (here, the jump buttons are marked-paragraph selecting buttons 918 and page-turning buttons 919). In FIG. 5, the second browsing window mainly displays the second paragraph. If the user clicks the marked-paragraph selecting button 918 directed to the previous marked paragraph, the first browsing window 911 would display a previous original paragraph 913 whose recognizing confidence value is less than the threshold value (here, the first browsing window displays a first original paragraph), and the second browsing window 912 would display the reflow-content paragraph 914 corresponding to the original paragraph 913 displayed within the first browsing window 911 (here, the second browsing window 912 displays a first reflow-content paragraph). Conversely, if the user clicks the marked-paragraph selecting button 918 directed to the foregoing marked paragraph, then the first browsing window 911 would display a foregoing original paragraph 913 whose recognizing confidence value is less than the threshold value (here, the first browsing window 911 displays a third original paragraph), and the second browsing window 912 would display the reflow-content paragraph 914 corresponding to the original paragraph 913 displayed within the first browsing window 911 (here, the second browsing window 912 displays a third reflow-content paragraph). Additionally, if the user selects the left page-turning button 919, the second browsing window 912 would then turn to display the last page with respect to the current page having reflow-content paragraphs 914. Conversely, if the user selects the right page-turning button 919, the second browsing window 912 would then turn to display the next page with respect to the current page having reflow-content paragraphs 914. Accordingly, the page-turning buttons 919 allow the reflow-content paragraphs 914 to be sequentially displayed within the second browsing window 912.

In some embodiments, when one of the browsing windows 911, 912 is scrolled by the user, the other browsing window would be scrolled automatically to display texts corresponding to the texts displayed within the manual-scrolled browsing window. Accordingly, the user can compare the reflow-content paragraphs 914 with the original paragraphs 913 in a convenient manner.

As shown in FIG. 5, the edit interface 910 further comprises a save button 921 for saving all of the at least one recognized reflow-content paragraph 914 as a reflow-content electronic book file. In other words, after the user has checked all the marked reflow-content paragraphs 914 (step S600), the save button 921 is clicked to store all the reflow-content paragraphs 914 (step S700). Here, the reflow-content electronic book file may be an ePub file or other reflow-content files (e.g., html files).

In one embodiment, a non-text recognizing step is carried out prior to the step S500. Broken fragments recognized in the reflow-content paragraph 914 may be charts like block diagrams or flowcharts in the original paragraph, accordingly, the recognized pictures or charts may be regarded as non-text blocks. And then, an interval between each two adjacent non-text blocks is recognized. Last, adjacent non-text blocks with the interval there between being less than a predefined value are combined to form a chart, a graph, or a table. Based on this, the possibility in paragraph misjudging may be reduced. In other words, the broken fragments would not be regarded as individual reflow-content paragraphs 914.

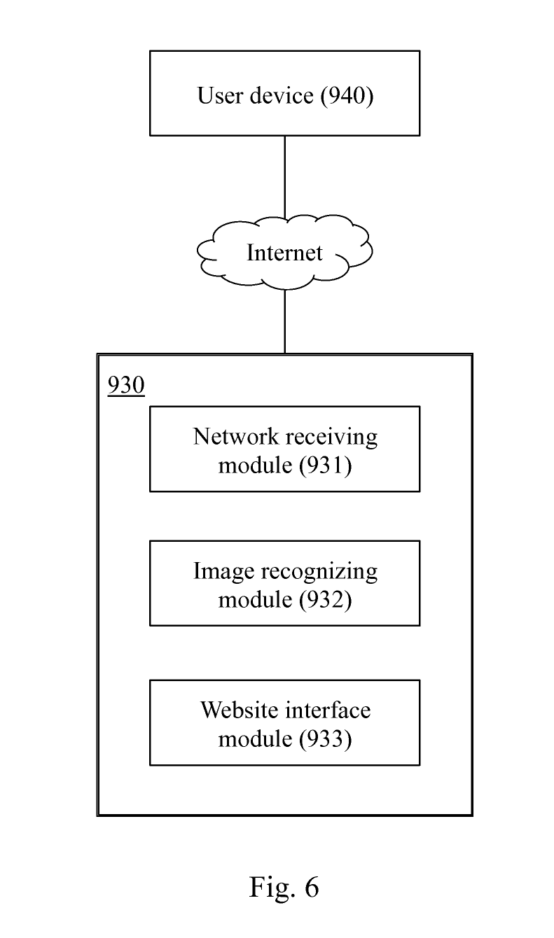

FIG. 6 illustrates a schematic view of a website system 930 for generating reflow-content electronic book according to the instant disclosure. As shown in FIG. 6, the website system 930 comprises a network receiving module 931, an image recognizing module 932, and a website interface module 933. The website system 930 may be carried out by a website server. The website server may include a storage device (e.g., a hard disk), a computing processor (e.g., a CPU), a network card, etc.

The network receiving module 931 receives a digital file uploaded by a user device 940 (e.g., a personal computer) operated by a user. The image recognizing module 932 executes the steps S200 to S400. The network interface module 933 has the edit interface 910 to present the words of the reflow-content paragraph 914. In addition, those reflow-content paragraphs 914 whose recognizing confidence values are less than a threshold value are marked. Accordingly, the website system 930 can provide an online service for converting a digital file into a reflow-content electronic book and for editing the reflow-content electronic book, and the reflow-content electronic book may be downloaded by the user. Here, the website system 930 may be adapted with a member-login function. The detail of the member-login function is omitted here.

Based on the above, the method for generating reflow-content electronic book and the website system thereof may be adapted to the user to rapidly check those reflow-content paragraphs where errors might occur and allow the user to save the electronic book file promptly. In addition, the reflow-content electronic book generated by the method or the website system may be flexibly displayed on different devices having different sizes of screens. Furthermore, based on the paragraph recognizing step, the possibility of misrecognizing paragraphs can be reduced.

While the disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A method for generating reflow-content electronic book, comprising:
receiving a digital file, wherein the digital file comprises at least one page content;
recognizing a plurality of words of at least one original paragraph of the at least one page content, wherein the words are aligned into a plurality of lines along a writing direction;
recognizing an arrangement type of the lines;
connecting the words of the lines to form at least one reflow-content paragraph based on the arrangement type of the lines and calculating a recognizing confidence value corresponding to each of the at least one reflow-content paragraph;
displaying the words of the at least one reflow-content paragraph in an edit interface and marking the reflow-content paragraph having the recognizing confidence value less than a threshold value;
checking or revising the reflow-content paragraph which is marked in the edit interface by a user; and
saving all the at least one reflow-content paragraph as a reflow-content electronic book file.

2. The method for generating reflow-content electronic book according to claim 1, wherein in the step of recognizing a plurality of words of at least one original paragraph of the at least one page content, further comprises:
recognizing the words of each of the at least one page content and summarizing a two-dimensional coordinate of each of the words, wherein the two-dimensional coordinate comprises a horizontal coordinate and a vertical coordinate;
determining an upper boundary and a lower boundary based on the majority of the vertical coordinates of the words and determining a left boundary and a right boundary based on the majority of the horizontal coordinates of the words, and;
defining the words within the upper and lower boundaries and the left and right boundaries of each of the at least one page content as an article.

3. The method for generating reflow-content electronic book according to claim 2, wherein in the step of connecting the words of the lines to form at least one reflow-content paragraph based on the arrangement type, further comprises:
detecting an indentation distance of the at least one original paragraph; and
arranging the at least one reflow-content paragraph in the article based on the indentation distance of the original paragraph, wherein the at least one reflow-content paragraph corresponds to the at least one original paragraph.

4. The method for generating reflow-content electronic book according to claim 1, further comprising a non-text block recognizing step, wherein the non-text block recognizing step comprises:
recognizing a plurality of pictures or charts as non-text blocks;
recognizing an interval between two adjacent non-text blocks; and
combining two adjacent non-text blocks with the interval there between being less than a predefined value.

5. The method for generating reflow-content electronic book according to claim 1, wherein in the step of displaying the words of the at least one reflow-content paragraph in an edit interface and marking the reflow-content paragraph having the recognizing confidence value less than a threshold value, the edit interface further has a plurality of device options respectively corresponding to a plurality of display devices so as to allow a user to select one of the virtual display devices to display an image frame having the at least one reflow-content paragraph, wherein the sizes of screens of the virtual display devices are different.

6. A website system for generating reflow-content electronic book, comprising:
a network receiving module, receiving a digital file uploaded by a user, wherein the digital file comprises at least one page content;
an image recognizing module, recognizing a plurality of words of the at least one page content, wherein the words are aligned into a plurality of lines along a writing direction, and the image recognizing module recognizes an arrangement type of the lines, so that the image recognizing module connects the words of the lines to form at least one reflow-content paragraph based on the arrangement type of the lines and calculates a recognizing confidence value corresponding to each of the at least one reflow-content paragraph; and
a website interface module, comprising an edit interface to display the words of the at least one reflow-content paragraph, wherein the edit interface marks the reflow-content paragraph having the recognizing confidence value less than a threshold value.

7. The website system for generating reflow-content electronic book according to claim 6, wherein the edit interface has a first browsing window and a second browsing window parallel aligned with the first browsing window, the first browsing window displays the at least one page content, the second browsing window displays at least one recognized reflow-content paragraph corresponding to the at least one page content.

8. The website system for generating reflow-content electronic book according to claim 6, wherein the edit interface further comprises an edit tool set and a plurality of device options respectively corresponding to a plurality of virtual display devices, the device options allow the user to select one of the virtual display devices to display an image frame in the second browsing window, wherein the image frame has the at least one reflow-content paragraph, the sizes of screens of the virtual display devices are different, the edit tool set is provided for editing the at least one reflow-content paragraph displayed within the second browsing window.

9. The website system for generating reflow-content electronic book according to claim 6, wherein the edit interface further comprises a save button for saving all of the at least one recognized reflow-content paragraph as a reflow-content electronic book file.

10. The website system for generating reflow-content electronic book according to claim 6, wherein the edit interface further comprises a jump button for sequentially displaying at least one marked reflow-content paragraph in the second browsing window.
